(19) United States
(12) Patent Application Publication
(10) Pub. No.: US 2024/0129184 A1
(43) Pub. Date: Apr. 18, 2024

(54) SETTING CHANGING APPARATUS, SETTING CHANGING METHOD AND PROGRAM

(71) Applicant: NIPPON TELEGRAPH AND TELEPHONE CORPORATION, Tokyo (JP)

(72) Inventor: Katsuma MIYAMOTO, Tokyo (JP)

(73) Assignee: NIPPON TELEGRAPH AND TELEPHONE CORPORATION, Tokyo (JP)

(21) Appl. No.: 18/275,790

(22) PCT Filed: Feb. 9, 2021
(86) PCT No.: PCT/JP2021/004785

§ 371 Date: Aug. 3, 2023

(51) Int. Cl. H04L 41/0803; G06F 8/65

(52) U.S. Cl. CPC H04L 41/0803; G06F 8/65

(57) ABSTRACT

A setting changing apparatus includes a memory and a processor configured to determine whether software of a plurality of network devices, which are related to a redundant configuration, is being updated when an instruction of setting change for the plurality of network devices is input; and wait, when the software of any of the network devices is being updated, until the update of the software of the network device is completed and execute the setting change for the network device.

### TECHNICAL FIELD

The present invention relates to a setting changing apparatus, a setting changing method, and a program.

### BACKGROUND ART

When software programs (hereinafter simply referred to as “software”) of a router, a switch, and the like (hereinafter referred to as “network devices”) are to be updated, user communication may be blocked because the updating entails software change and restart of the main bodies of the network devices.

When the network devices are configured to have a 2N redundancy, the user communication is switched between 0 and 1 systems, and the software of the network devices on the standby side is updated, and thereby, the software can be updated while maintaining the user communication (see NPL 1).

### CITATION LIST

### Non-Patent Literature

[NLP 1] Cisco Systems, “In-Service Software Upgrade (ISSU)”, [online], Internet <URL: https://www.cisco.com/c/ja_jp/td/docs/switches/lan/catalyst_standalones/b-in-service-software-upgrade-issu.html>

### SUMMARY OF INVENTION

### Technical Problem

However, in a service in which network settings (settings for network devices) are dynamically changed as triggered by an operation of a service user (for example, a service in which a service user inputs an order of service subscription or change (service order or SO) on an operation screen (dashboard) of a web browser and the network settings are changed according to that order as triggered by the operation), although user communication is maintained when a service user inputs an SO during software updating, the following problem occurs upon the input of the network settings corresponding to the SO from the orchestrator.

The setting process according to the SO is not completed without input of the settings from the orchestrator into the network devices for which software is being updated. As a result, the settings are input only to the network devices on one side of the redundant configuration, and state inconsistency occurs between the 0 and 1 systems.

The present invention has been made in view of the above-mentioned point, and aims to avoid an occurrence of inconsistency among network devices in setting change during software updating for a group of network devices having a redundant configuration.

### Solution to Problem

In order to solve the above-described problem, a setting changing apparatus includes a determination unit that determines whether software of a plurality of network devices, which are related to a redundant configuration, is being updated when an instruction of setting change for the plurality of network devices is input, and a setting change unit that waits, when the software of any of the network devices is being updated, until the update of the software of the network device is completed and executes the setting change for the network device.

### Advantageous Effects of Invention

It is possible to avoid an occurrence of inconsistency among network devices in setting change during software update for a group of network devices having a redundant configuration.

### BRIEF DESCRIPTION OF DRAWINGS

FIG. 1 is a diagram illustrating a configuration example of a communication system according to a first embodiment.

FIG. 2 is a diagram illustrating a hardware configuration example of a user portal 10 according to the first embodiment.

FIG. 3 is a diagram illustrating a functional configuration example of a maintenance console 20, the user portal 10, and an orchestrator 30 according to the first embodiment.

FIG. 4 is a sequence diagram for describing an example of a processing procedure of a software update process according to the first embodiment.

FIG. 5 is a sequence diagram for describing an example of a processing procedure executed according to an SO in the first embodiment.

FIG. 6 is a diagram illustrating a functional configuration example of a maintenance console 20, a user portal 10, and an orchestrator 30 according to a second embodiment.

FIG. 7 is a sequence diagram for describing an example of a processing procedure of a software update process according to the second embodiment.

FIG. 8 is a sequence diagram for describing an example of a processing procedure executed according to an SO in the second embodiment.

FIG. 9 is a diagram illustrating a functional configuration example of a maintenance console 20, a user portal 10, and an orchestrator 30 according to a third embodiment.

FIG. 10 is a sequence diagram for describing an example of a processing procedure of a software update process according to the third embodiment.

FIG. 11 is a sequence diagram for describing an example of a processing procedure executed according to an SO in the third embodiment.

### DESCRIPTION OF EMBODIMENTS

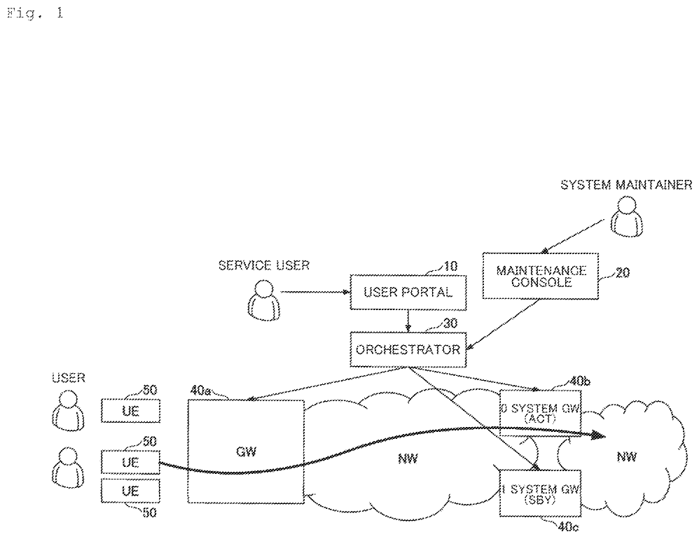

Embodiments of the present invention will be described below with reference to the accompanying drawings. FIG. 1 is a diagram illustrating a configuration example of a communication system according to a first embodiment. As illustrated in FIG. 1, the communication system includes a user portal 10, a maintenance console 20, an orchestrator 30, a plurality of gateways (GWs) 40, one or more user devices (UEs) 50, and the like. The orchestrator 30 is capable of communicating with the user portal 10 and each of the GWs 40.

The UE 50 is a device for transmitting and receiving packet communication, and is used by a user of a service provided in the communication system (hereinafter simply referred to as a “service”). For example, a PC, a smartphone, an IoT (Internet of things) device, or the like is an example of the UE 50. In FIG. 1, the arrow starting from the UE 50 indicates an example of a path of a packet transmitted from the UE 50. A person who uses the service through the UE 50 is called a “user”. Further, one user may have a plurality of UEs 50.

The GW 40 is a generic device for processing packets flowing on a network, and is an example of a network device in this embodiment. Traffic of one or more UEs 50 passes one or more GWs 40 or GW 40 pairs (pairs of GWs 40 of a redundant configuration) in multiple stages. For example, generic network devices (devices having network functions such as L2/L3 transfer, firewall, VPN connection device, DPI, and proxy) such as EPC (S-GW 40, P-GW 40, etc.), 5GC (UPF, etc.), base stations (eNodeB, gNodeB, etc.), routers, and switches is an example of the GWs 40. The GWs 40 may be physical devices or virtual devices.

Further, although each GW 40 may be configured as a single device like a GW 40a, it is desirable for the GW 40 to have a redundancy configuration (for example, a redundancy pair of 0 system and 1 system constituting one set) like a GW 40b and a GW 40c. The redundant configuration is not limited to a configuration such as 2N, N+1, N+M, or the like. In addition, combinations of states such as “active” and “standby” are not limited.

The user portal 10 is a computer that receives an input of a service order (SO) from a service user via a remote graphical user interface (GUI) (web page, etc.) or a command line interface (CLI) (via a network), and functions as a functional unit that triggers a network setting (mainly setting change for the GW 40). An SO refers to order information regarding service subscription, change, or the like. As will be described later, in the present embodiment, an SO serves as a trigger for changing settings for the GW 40. For this reason, an SO substantially corresponds to an instruction to change settings for the GW 40.

A service user refers to a person who inputs an SO on the user side of the service, and a service user itself may be the user of the service, or the service user itself may be an operator (system maintainer), or the like. For example, in the case of a service for managing mobile terminals of a company, it is assumed that the service user is a system department of the company, the UE 50 is a company smartphone of each employee (each user), and the system department collectively manages company smartphones from the user portal 10. On the other hand, if the service is for IoT, it is assumed that IoT terminals (UE 50) owned by the service user itself are collectively managed, and thus the users of the UEs 50 are the same as the service user. The user portal 10 inputs (transmits) the received SO to the orchestrator 30.

The maintenance console 20 is a device that functions as a functional unit that receives an input of an instruction to update a software program (hereinafter simply referred to as “software”) of the GW 40 from the system maintainer, and transmits the update instruction to the orchestrator 30. A user interface (GUI or the like) for receiving the input of the update instruction may be provided as a web page or implemented by a dedicated program installed in a console.

The system maintainer is a person who performs an operation (input of an update instruction or the like) for updating the software of the GW 40. Further, although the present embodiment shows an example in which the update instruction is input via the maintenance console 20, the update instruction from the system maintainer may be input via the orchestrator 30, or may be input directly to the GW 40.

The orchestrator 30 is a computer that functions as a functional unit for performing setting input (setting change) to a device (GW 40) requiring setting change in accordance with an SO from the user portal 10 and controlling software update for the GW 40 in accordance with an update instruction from the maintenance console 20, and includes a device (such as an openflow controller) capable of operating the GW 40. Further, the orchestrator 30 may be able to control (perform setting change or update) the GW 40 via a rest-API. However, other application program interfaces (APIs) may be used as long as they are APIs capable of controlling the GW 40.

Further, the orchestrator 30 may be implemented by using the same computer as the user portal 10, or the GW 40 may serve as the orchestrator 30.

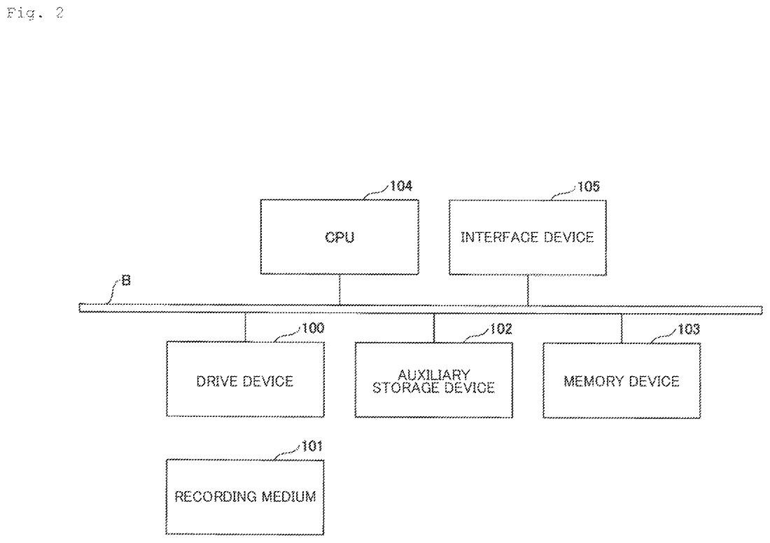

FIG. 2 is a diagram illustrating a hardware configuration example of the user portal 10 according to an embodiment of the present invention. The user portal 10 illustrated in FIG. 2 includes a drive device 100, an auxiliary storage device 102, a memory device 103, a CPU 104, an interface device 105, and the like, which are connected to each other via a bus B.

A program that implements the processing of the user portal 10 is provided by a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files, data, and the like.

When an instruction to activate the program is given, the memory device 103 reads the program from the auxiliary storage device 102 and stores the program. The CPU 104 implements functions of the user portal 10 in accordance with the program stored in the memory device 103. The interface device 105 is used as an interface for connection to a network.

Further, the orchestrator 30, the maintenance console 20, and the GWs 40 may also have the hardware configuration illustrated in FIG. 2.

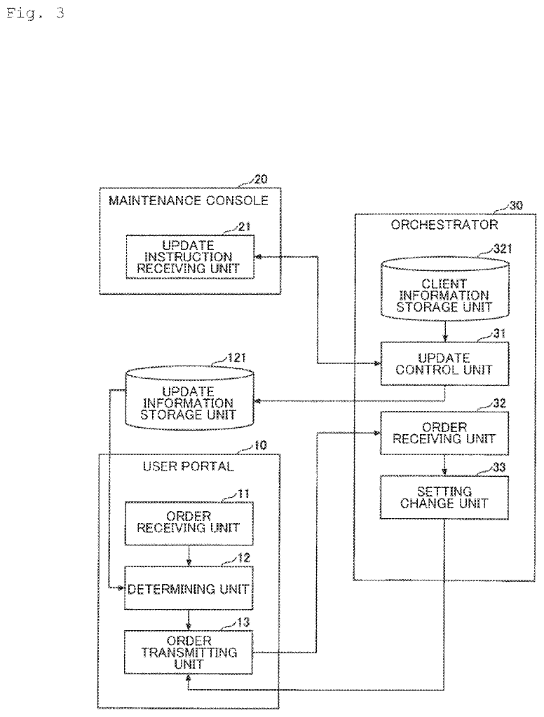

FIG. 3 is a diagram illustrating a functional configuration example of the maintenance console 20, the user portal 10, and the orchestrator 30 according to the first embodiment. In FIG. 3, the maintenance console 20 has an update instruction receiving unit 21. The update instruction receiving unit 21 is implemented by processing to have a CPU of the maintenance console 20 execute one or more programs installed in the maintenance console 20.

The user portal 10 includes an order receiving unit 11, a determination unit 12, and an order transmitting unit 13. These units are implemented by processing to have the CPU 104 execute one or more programs installed in a console. The user portal 10 also uses an update information storage unit 121. The update information storage unit 121 can be implemented by using, for example, a storage device that can be connected to the auxiliary storage device 102 or the console via a network, or the like.

The orchestrator 30 includes an update control unit 31, an order receiving unit 32, and a setting change unit 33. Each of these units is implemented by processing to have a CPU of the orchestrator 30 execute one or more programs installed in the orchestrator 30. The orchestrator 30 also uses a client information storage unit 321. The client information storage unit 321 can be implemented by using, for example, an auxiliary storage device included in the orchestrator 30 or a storage device that can be connected to the orchestrator 30 via a network, or the like.

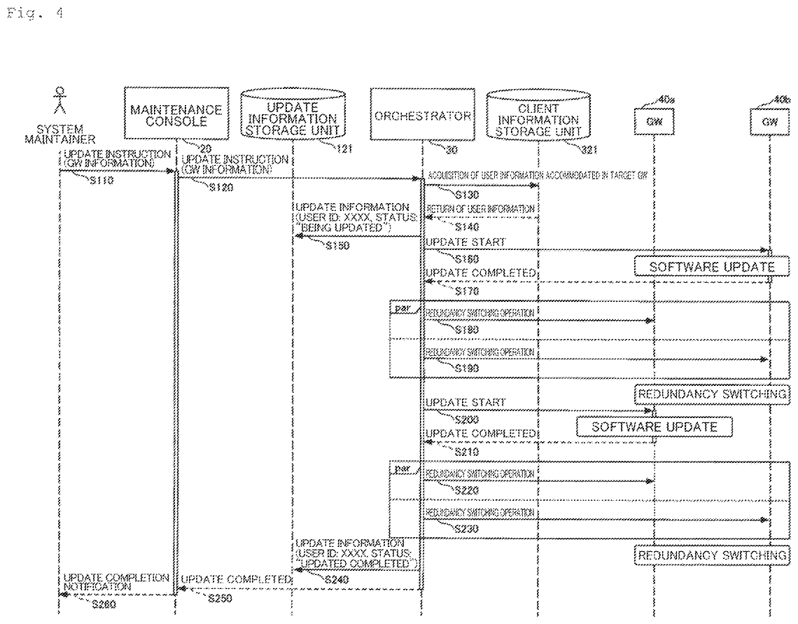

Hereinafter, a processing procedure performed in the first embodiment will be described. FIG. 4 is a sequence diagram for describing an example of a processing procedure of a software update process according to the first embodiment.

In step S110, the update instruction receiving unit 21 of the maintenance console 20 receives a software update instruction from the system maintainer. The update instruction includes information (which will be referred to as “GW information” below) indicating a GW 40 to be updated (which will be referred to as a “target GW 40” below). Subsequently, the update instruction receiving unit 21 transmits the update instruction to the orchestrator 30 (S120).

Upon receiving the update instruction, the update control unit 31 of the orchestrator 30 acquires the user information (user ID) of the user accommodated in the target GW 40 (which will be referred to as a “target user” below) from the client information storage unit 321 (S130 and S140). That is, the client information storage unit 321 stores information indicating which GW 40 each user is accommodated in (information in which a user ID is associated with the ID of a GW 40). Thus, the update control unit 31 acquires user information associated with the GW information included in the update instruction from the client information storage unit 321.

Subsequently, the update control unit 31 records update information (user ID and status) indicating that the status of the GW 40 accommodating the target user in which the software is being updated in the update information storage unit 121 in association with the user ID of the target user (S150). The status refers to information indicating the state of the software of the GW 40 being updated, and values thereof include “being updated” or “update completed”. In step S150, “being updated” is recorded as a status.

Then, the update control unit 31 executes control of software update for the target GW 40 (here, a pair of GW 40b and GW 40c is assumed). However, since user traffic is flowing to the GW 40b serving as an active system, communication interruption occurs when updating is performed immediately.

Then, the update control unit 31 first starts software updating from the GW 40c that is a standby system (S160). When updating of the GW 40c is completed (S170), the update control unit 31 executes a redundancy switching operation to swap the standby system and the active system (S180 and S190). That is, the GW 40b serves as a standby system, and the GW 40c serves as an active system. As a result, user traffic flows to the GW 40c.

Then, the update control unit 31 starts control of software update for the GW 40b that has become the new standby system (S200). When the software update for the GW 40b is completed (that is, updating for all GWs 40 of the redundant configuration is completed) (S210), the update control unit 31 brings the GW 40b back to an active system by executing the redundancy switching operation again, and brings the GW 40c back to a standby system (S220 and S230). However, the redundancy switching operation performed again is not essential, and normal operations may be continued while the GW 40b remains as the standby system and the GW 40c remains as the active system. This also applies to second and third embodiments.

Subsequently, the update control unit 31 records update information indicating completion of the update with respect to the target user in the update information storage unit 121 (S240). That is, the update control unit 31 updates the status stored in the update information storage unit 121 in association with the user ID of the target user to “update completed”. Such updating of the status corresponds to deletion of information indicating that the software is being updated with respect to the target user.

Subsequently, the update control unit 31 transmits a response indicating the completion of update to the update instruction receiving unit 21 of the maintenance console 20 (S250). Upon receiving the response, the update instruction receiving unit 21 notifies the system maintainer of the completion of update (S260).

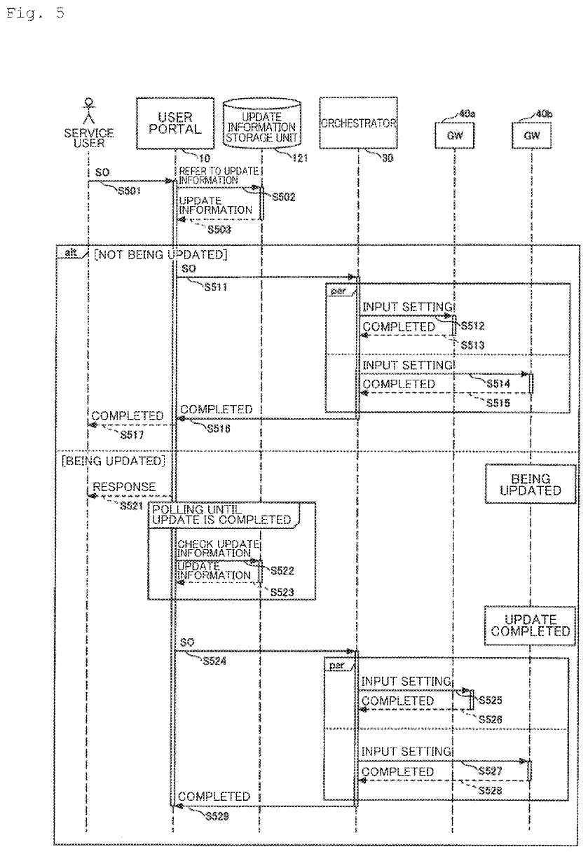

FIG. 5 is a sequence diagram for describing an example of a processing procedure executed according to an SO in the first embodiment.

In step S501, the order receiving unit 11 of the user portal 10 receives an input of an SO from the service user. The SO includes the user ID of a user to be changed with respect to the service (which will be referred to as a “target user” below).

Subsequently, the determination unit 12 refers to the update information storage unit 121 to determine whether the software of the GW 40 accommodating the target user is being updated (S502 and S503). That is, the determination unit 12 determines that the software is being updated with respect to the target user if the status indicating “being updated” is stored in the update information storage unit 121 in association with the user ID of the target user.

When the software is not being updated with respect to the target user, steps S511 to S517 are performed.

In step S511, the order transmitting unit 13 transmits the input SO to the orchestrator 30. When the order receiving unit 32 of the orchestrator 30 receives the SO, the setting change unit 33 changes the settings of the GWs 40 (here, the pair of the GW 40b and GW 40c) corresponding to the user ID included in the SO by inputting the settings corresponding to the SO to the GWs 40 (S512 to S515). Further, the GW 40 corresponding to the user ID included in the SO can be specified by referring to the client information storage unit 321. When the setting change is completed for all of the corresponding GWs 40, the setting change unit 33 transmits a response indicating the completion of the setting change to the user portal 10 (S516). Upon receiving the response, the order transmitting unit 13 of the user portal 10 notifies the service user of the completion of the setting change according to the SO (S517).

On the other hand, when the software is being updated with respect to the target user, steps S521 to S529 are performed.

In step S521, the determination unit 12 notifies the service user of the completion of the setting change according to the SO, or the message “it takes time for reflection because maintenance is underway” or the like. Subsequently, the order transmitting unit 13 waits for completion of update related to the target user by repeatedly referring to the update information storage unit 121 (for example, at regular intervals) (S522 and S523). When the status with respect to the target user changes to “update completed”, the order transmitting unit 13 detects the completion of update. When the completion of the update is detected by the order transmitting unit 13, processing similar to steps S511 to S516 is executed in steps S524 to S529.

As described above, according to the first embodiment, the setting change in accordance with an SO can be continued even during a software update process. Thus, when settings are changed during update of software for a group of network devices (a group of GWs 40) having a redundant configuration, it is possible to avoid an occurrence of inconsistency among the network devices (among the GWs 40) Next, a second embodiment will be described. In the second embodiment, different points from the first embodiment will be described. Points which are not mentioned particularly in the second embodiment may be similar to those of the first embodiment.

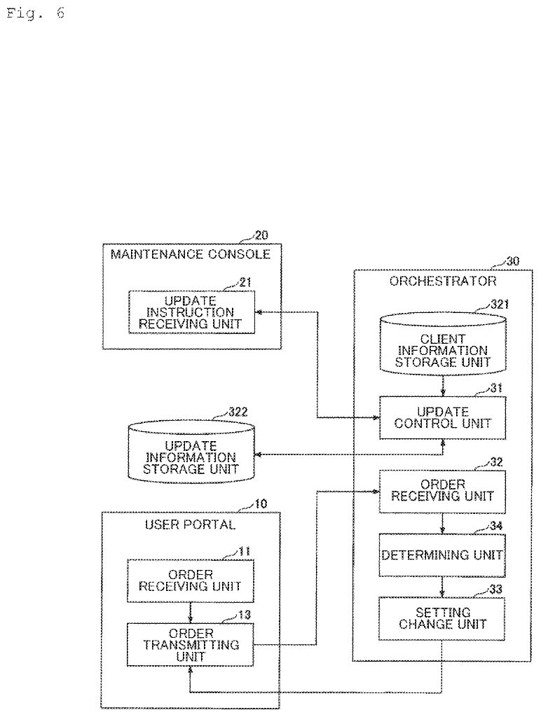

FIG. 6 is a diagram illustrating a functional configuration example of a maintenance console 20, a user portal 10, and an orchestrator 30 according to the second embodiment. In FIG. 6, the same parts as those in FIG. 3 are denoted by the same reference numerals, and the description thereof will be omitted.

In FIG. 6, the user portal 10 does not include the determination unit 12. The user portal 10 does not use the update information storage unit 121 either.

On the other hand, the orchestrator 30 further includes a determination unit 34. The determination unit 34 is implemented by processing to have a CPU of the orchestrator 30 execute one or more programs installed in the orchestrator 30. The orchestrator 30 also uses an update information storage unit 322. The update information storage unit 322 can be implemented by using, for example, an auxiliary storage device included in the orchestrator 30 or a storage device that can be connected to the orchestrator 30 via a network, or the like.

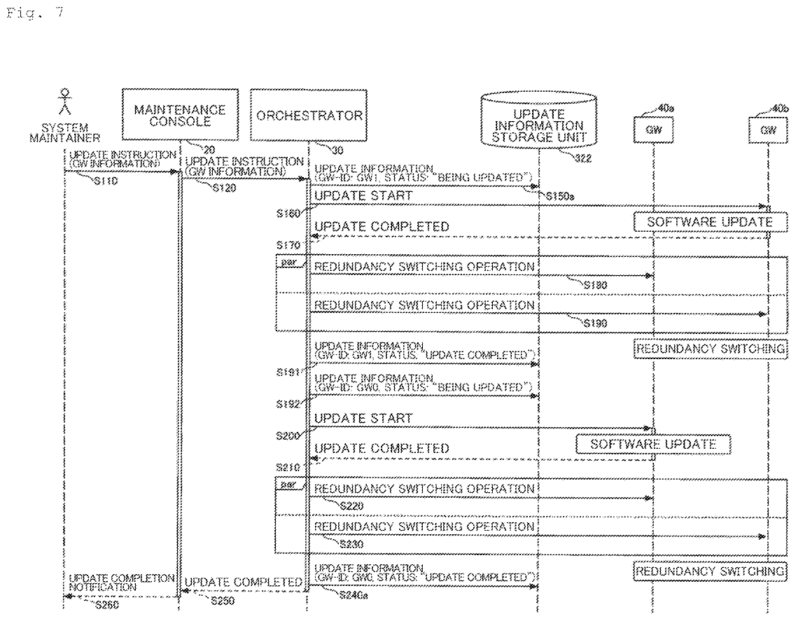

FIG. 7 is a sequence diagram for describing an example of a processing procedure of a software update process according to the second embodiment. In FIG. 3, the same steps as those in FIG. 4 are given the same step numbers, and description thereof is omitted.

In FIG. 7, step S150 is replaced with step S150a. In addition, steps S191 and S192 are executed between step S190 and step S200. Furthermore, step S240 is replaced with step S240a.

In step S150a, the update control unit 31 associates the ID of the GW 40 serving as a standby system (here, the GW 40c) of the target GWs 40 with a status of software update for the GW 40, and records the associated information in the update information storage unit 322. In step S150a, “being updated” is recorded as the status.

That is, although the status is stored for each user (in units of users) in the update information storage unit 121 in the first embodiment, the status is stored for each GW 40 (in units of GWs 40) in the update information storage unit 322 in the second embodiment. For this reason, the status can be managed for each GW 40 in the second embodiment.

When software update for the GW 40c of the standby system is completed (S160 and S170) and the GW 40b is switched to a standby system in a redundancy switching operation (S180 and S190), the update control unit 31 changes the status of the GW 40c to “update completed” (S191), and records update information indicating that the status of the GW 40b is “being updated” in the update information storage unit 322 (S192). That is, information indicating that the software of the GW 40c is being updated is deleted, and information indicating that the software of the GW 40b is being updated is recorded.

When software update for the GW 40b is completed (S200 and S210) and the GW 40b is switched to an active system in a redundancy switching operation (S220 and S230), the update control unit 31 changes the status of the GW 40b to “update completed” (S240a). That is, information indicating that the software of the GW 40b is being updated is deleted.

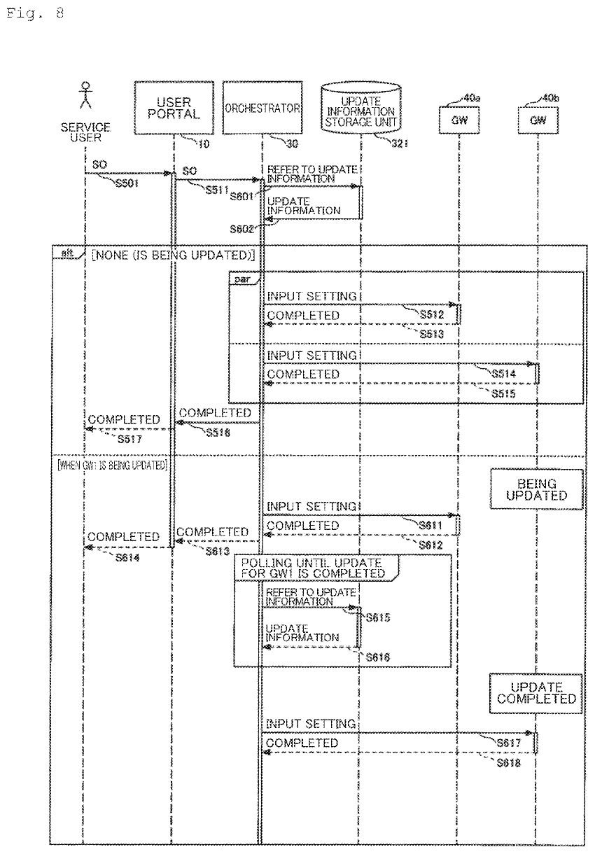

FIG. 8 is a sequence diagram for describing an example of a processing procedure executed according to an SO in the second embodiment. In FIG. 8, the same steps as those in FIG. 5 are denoted by the same step numbers, and the description will be appropriately omitted.

When the order receiving unit 11 of the user portal 10 receives an input of an SO (S501), the order transmitting unit 13 transmits the SO to the orchestrator 30 (S511).

When the order receiving unit 32 of the orchestrator 30 receives the SO, the determination unit 34 refers to the update information storage unit 322 and determines whether software of each GW 40 (hereinafter referred to as a “target GW 40”) accommodating a target user is being updated (S601 and S602). Each target GW 40 can be specified by referring to the client information storage unit 321. That is, the determination unit 34 determines that the target GW 40 whose ID is stored in the update information storage unit 322 in association with the status indicating “being updated” is being updated.

When none of the target GWs 40 is being updated, steps S512 to S517 are executed.

On the other hand, when any of the target GWs 40 is being updated, steps S611 to S618 are executed. In this case, it is assumed that the GW 40c as the standby system is being updated and the GW 40b as the active system is not being updated. In this case, the setting change is performed for the GW 40b which is not being updated, and the setting change is performed for the GW 40c after completion of update.

Specifically, the setting change unit 33 first changes the settings for the GW 40b (S611 and S612). Subsequently, processing similar to steps S516 and S517 is executed (S613 and S614).

Subsequently, the setting change unit 33 waits for completion of update for the GW 40c by repeatedly referring to the update information storage unit 322 (for example, at regular intervals) (S615 and S616). When the status of the GW 40c changes to “update completed”, the setting change unit 33 detects the completion of the update. When the completion of the update is detected, the setting change unit 33 changes the setting for the GW 40c (S617 and S618).

According to the second embodiment, it is possible to obtain the same effects as those of the first embodiment as described above.

Furthermore, although it is necessary to wait for the setting change until update of both GWs 40 of the redundant configuration is completed in the first embodiment, the setting change can be performed from the GW 40 which is not being updated in advance, and thus the setting change according to the SO can be immediately reflected without waiting for the update of both GWs 40 in the second embodiment.

Next, a third embodiment will be described. In the third embodiment, different points from those of the first or second embodiment will be described. Points which are not mentioned particularly in the third embodiment may be similar to those of the first or second embodiment.

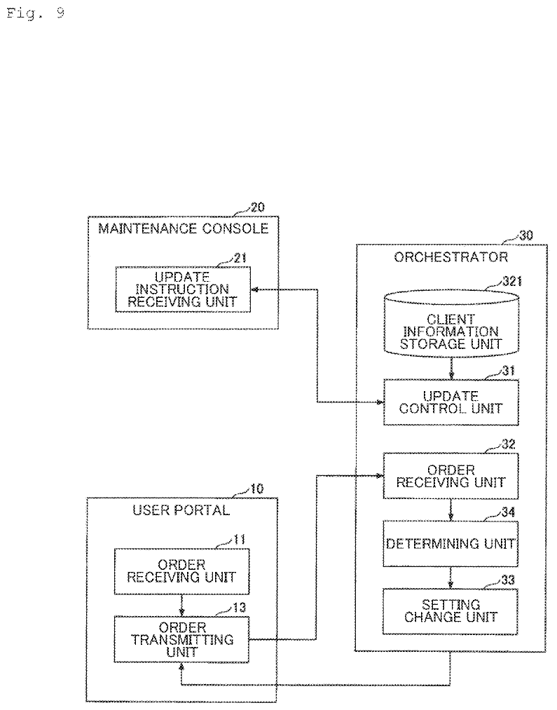

FIG. 9 is a diagram illustrating a functional configuration example of a maintenance console 20, a user portal 10, and an orchestrator 30 according to the third embodiment. In FIG. 9, the same portions as those in FIG. 6 are denoted by the same reference numerals, and description thereof will be omitted. The update information storage unit 322 is not used in the third embodiment as illustrated in FIG. 9.

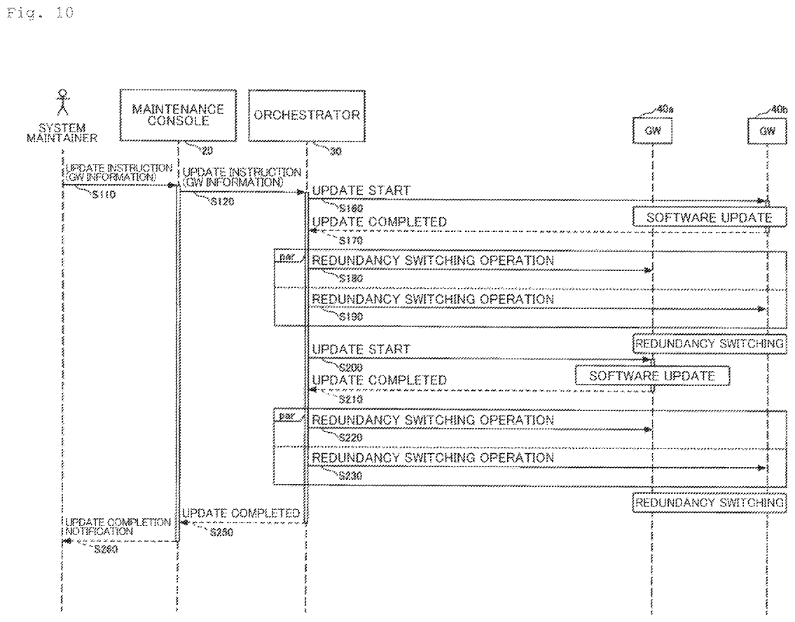

FIG. 10 is a sequence diagram for describing an example of a processing procedure of a software update process according to the third embodiment. In FIG. 10, the same steps as those in FIG. 7 are given the same step numbers, and description thereof is omitted.

As described with reference to FIG. 9, the update information storage unit 322 is not used in the third embodiment. Thus, FIG. 10 illustrates a processing procedure in which the recording processes (S150a, S191, S192, and S240a) performed with respect to the update information storage unit 322 in FIG. 7 are excluded.

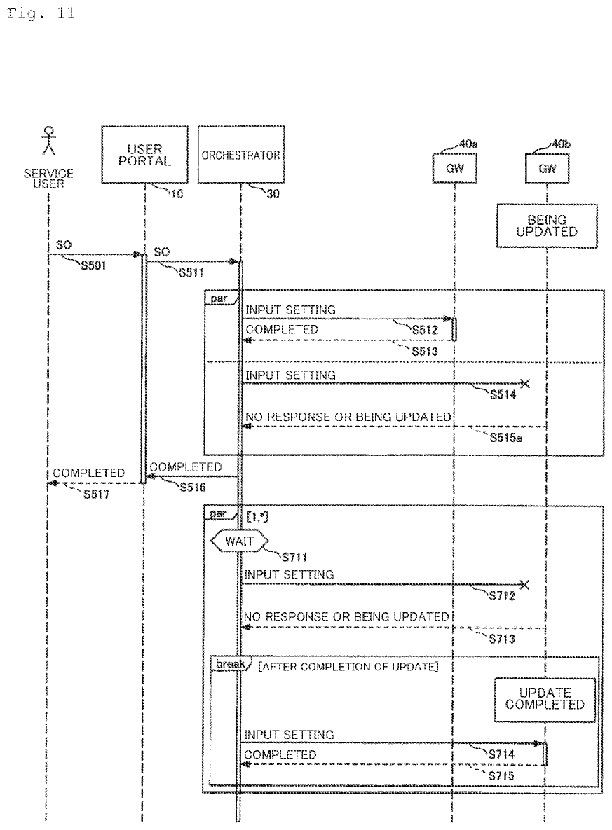

FIG. 11 is a sequence diagram for describing an example of a processing procedure executed according to an SO in the third embodiment. In FIG. 11, the same steps as those in FIG. 8 are given the same step numbers, and description thereof will be appropriately omitted.

In the third embodiment, the setting change unit 33 tries setting change for each target GW 40 in a speculative manner (S512 and S513). It is assumed that software of the GW 40c is being updated at this timing. In this case, there is no normal response to the setting change or a response indicating that the software is being updated is returned from the GW 40c. The determination unit 34 determines whether each target GW 40 is being updated based on the presence or absence of a normal response or a response indicating that the software is being updated. The normal response means a response indicating that the setting change has been completed.

After the execution of step S516, the setting change unit 33 waits for a fixed period of time (S711), and then re-executes the setting change to the GW 40c whose setting change has not been completed (S712). The setting change unit 33 repeats step S711 and the subsequent steps when there is no response or when a response indicating that update is being performed is returned (S713). After that, when update of the GW 40c is completed, the setting change for the GW 40c succeeds (S714 and S715). That is, the setting change unit 33 repeats the setting change until the setting change for the GW 40c is successful.

According to the third embodiment, it is possible to obtain the same effects as those of the first embodiment as described above.

Furthermore, in the third embodiment, since neither the update information storage unit 121 nor the update information storage unit 322 is necessary, the functional configuration can be simplified.

However, even when the software is not being updated, there is a possibility that the software is erroneously recognized as being updated when a failure occurs in the GW 40 itself or the network, and thus it is desirable to limit the duration and the number of times of time-out or the like on the repetition of step S711 and the subsequent steps.

Further, in this embodiment, the user portal 10 and the orchestrator 30 are examples of a setting changing apparatus. The update information storage unit 121 or the update information storage unit 322 is an example of a storage unit.

Although embodiments of the present invention have been described in detail above, the present invention is not limited to the specific embodiments described above, and various modifications and changes can be made within the scope of the gist of the present invention described in the claims.

### REFERENCE SIGNS LIST

10 User portal
11 Order receiving unit
12 Determination unit
13 Order transmitting unit
20 Maintenance console
21 Update instruction receiving unit
30 Orchestrator
31 Update control unit
32 Order receiving unit
33 Setting change unit
34 Determination unit
40 GW
50 UE
100 Drive device
101 Recording medium
102 Auxiliary storage device
103 Memory device
104 CPU
105 Interface device
121 Update information storage unit
321 Client information storage unit
322 Update information storage unit
B Bus

1. A setting changing apparatus comprising:
a memory, and
a processor configured to:
determine whether software of a plurality of network devices, which are related to a redundant configuration, is being updated when an instruction of setting change for the plurality of network devices is input; and
wait, when the software of any of the network devices is being updated, until the update of the software of the network device is completed and execute the setting change for the network device.

2. The setting changing apparatus according to claim 1, wherein the processor executes the setting change for the network device whose software is not being updated even when the software of other network devices is being updated.

3. The setting changing apparatus according to claim 1, wherein the processor repeats the setting change until the setting change is successful for the network device whose software is being updated.

4. The setting changing apparatus according to claim 1, wherein the processor is further
configured to update the software for a first network device as a standby system among the plurality of network devices, then swap an active system and a standby system, and update the software for a second network device that has become a new standby system,
wherein the processor records information indicating that update is being performed for a user accommodated in the plurality of network devices in a storage upon start of update for the first network device, and deletes the information from the storage upon completion of the update for the second network device,
wherein the processor determines that the update is being performed when the information is stored in the storage, and
wherein the processor waits for the setting change until the information is deleted from the storage.

5. The setting changing apparatus according to claim 1, wherein the processor is further configured to update the software for a first network device as a standby system among the plurality of network devices, then swap an active system and a standby system, and update the software for a second network device that has become a new standby system,
wherein the processor records information indicating that update is being performed for the network device in a storage upon start of update for each of the network devices, and deletes the information from the storage upon completion of the update for the network device, and
wherein the processor waits for the setting change for the network device whose information is recorded in the storage.

6. A setting changing method executed by a computer including a memory and a processor, the method comprising:
determining whether software of a plurality of network devices, which are related to a redundant configuration, is being updated when an instruction of setting change for the plurality of network devices is input; and
waiting, when the software of any of the network devices is being updated, until the update of the software of the network device is completed and executing the setting change for the network device.

7. A non-transitory computer-readable recording medium having computer-readable instructions stored thereon, which, when executed, cause a computer to function as the setting changing apparatus according to claim 1.
